(19) United States
(12) Patent Application Publication
(10) Pub. No.: US 2014/0078225 A1
(43) Pub. Date: Mar. 20, 2014

(54) INKJET PRINT HEAD

(71) Applicant: SAMSUNG ELECTRO-MECHANICS CO., LTD., Suwon (KR)

(72) Inventors: Yoon Sok PARK, Suwon (KR); Pil Joong Kang, Suwon (KR); Hwa Sun Lee, Suwon (KR); Seung Joo Shin, Suwon (KR)

(73) Assignee: SAMSUNG ELECTRO-MECHANICS CO., LTD., Suwon (KR)

(21) Appl. No.: 13/742,862

(22) Filed: Jan. 16, 2013

(30) Foreign Application Priority Data
Sep. 20, 2012 (KR) 10-2012-0104295

(51) Int. Cl. B41J 2/17

(52) U.S. Cl. CPC B41J 2/17
USPC 347/85; 347/93

(57) ABSTRACT

There is provided an inkjet print head, including: a first pressure chamber connected to a common channel; a second pressure chamber connected to the common channel and disposed in parallel with the first pressure chamber; a connection channel connecting the first pressure chamber and the second pressure chamber; and a nozzle formed in the first pressure chamber or the second pressure chamber.

### CROSS-REFERENCE TO RELATED APPLICATIONS

This application claims the priority of Korean Patent Application No. 10-2012-0104295 filed on Sep. 20, 2012, in the Korean Intellectual Property Office, the disclosure of which is incorporated herein by reference.

### BACKGROUND OF THE INVENTION

1. Field of the Invention

The present invention relates to an inkjet print head, and more particularly, to an inkjet print head capable of improving ink discharge efficiency through ink circulation.

2. Description of the Related Art

An inkjet print head may print a desired figure, shape or pattern by discharging micro-sized ink droplets (or a liquid industrial material) through a nozzle.

However, the above-mentioned inkjet print head has a disadvantage in that a discharge performance thereof may be degraded over a long period of time. For example, since foreign objects or air bubbles contained in ink may interrupt the discharge of ink through nozzles, they may degrade discharge efficiency of the inkjet print head.

Therefore, the development of an inkjet print head capable of decreasing the degradation of discharge efficiency of the inkjet print head due to the foreign objects or the air bubbles contained in the ink is required.

Meanwhile, examples of the related art associated with the inkjet print head include Patent Documents 1 and 2. Patent Document 1 discloses the use of a plurality of actuators, and Patent Document 2 discloses that a common channel 55 and a pressure chamber 52a are connected to each other by an ink supply channel 56 and an ink circulation channel 57.

However, these Patent Documents do not only recognize a problem due to foreign objects or air bubbles contained in ink, but also do not disclose any configuration for solving the above-mentioned problem.

### RELATED ART DOCUMENT

(Patent Document 1) JP 2010-221443A
(Patent Document 2) JP 2008-200902A

### SUMMARY OF THE INVENTION

An aspect of the present invention provides an inkjet print head capable of improving ink discharge efficiency by smoothly circulating ink.

According to an aspect of the present invention, there is provided an an inkjet print head, including: a first pressure chamber connected to a common channel; a second pressure chamber connected to the common channel and disposed in parallel with the first pressure chamber; a connection channel connecting the first pressure chamber and the second pressure chamber; and a nozzle formed in the first pressure chamber or the second pressure chamber.

The inkjet print head may further include a first actuator disposed on the first pressure chamber and a second actuator disposed on the second pressure chamber.

The connection channel may include: a first connection channel connecting one end of the first pressure chamber and one end of the second pressure chamber; and a second connection channel connecting the other end of the first pressure chamber and the other end of the second pressure chamber.

The first connection channel and the second connection channel may be formed at different heights.

The inkjet print head may further include: a first check valve installed in the first connection channel and only allowing ink flow from the first pressure chamber to the second pressure chamber; and a second check valve installed in the second connection channel and only allowing ink flow from the second pressure chamber to the first pressure chamber.

The connection channel may have a filter member capable of filtering foreign objects contained in ink mounted thereon.

According to another aspect of the present invention, there is provided an inkjet print head, including: a first pressure chamber connected to a first common channel; a second pressure chamber connected to a second common channel and disposed in parallel with the first pressure chamber; a connection channel connecting the first pressure chamber and the second pressure chamber; and a nozzle formed in the first pressure chamber or the second pressure chamber.

The first common channel may be connected to an ink supplying part and the second common channel may be connected to an ink recovering part.

The inkjet print head may further include a degassing device connected to the second common channel and filtering or removing air bubbles contained in ink.

The ink supplying part and the ink recovering part may be connected to each other so that ink is circulated.

The inkjet print head may further include a first actuator disposed on the first pressure chamber and a second actuator disposed on the second pressure chamber.

The connection channel may include: a first connection channel connecting one end of the first pressure chamber and one end of the second pressure chamber; and a second connection channel connecting the other end of the first pressure chamber and the other end of the second pressure chamber.

The first connection channel and the second connection channel may be formed at different heights.

The inkjet print head may further include a first check valve installed in the first connection channel and only allowing ink flow from the first pressure chamber to the second pressure chamber; and a second check valve installed in the second connection channel and only allowing ink flow from the second pressure chamber to the first pressure chamber.

The connection channel or the second common channel may have a filter member capable of filtering foreign objects contained in ink mounted thereon.

### BRIEF DESCRIPTION OF THE DRAWINGS

The above and other aspects, features and other advantages of the present invention will be more clearly understood from the following detailed description taken in conjunction with the accompanying drawings, in which:

FIGS. 1 and 2 are main configuration views showing an inkjet print head according to a first embodiment of the present invention;

FIG. 3 is a partially cut-away perspective view showing the inkjet print head according the first embodiment of the present invention;

FIG. 4 is a cross-sectional view taken along line A-A of the inkjet print head shown in FIG. 3;

FIG. 5 is a cross-sectional view taken along line B-B of the inkjet print head shown in FIG. 3;

FIG. 6 is a cross-sectional view taken along line C-C of the inkjet print head shown in FIG. 3;

FIG. 7 is a cross-sectional view describing another form of the inkjet print head taken along line C-C of the inkjet print head shown in FIG. 3;

FIG. 8 is a cross-sectional view describing another form of the inkjet print head taken along line C-C of the inkjet print head shown in FIG. 3;

FIG. 9 is a main configuration view showing an inkjet print head according to a second embodiment of the present invention;

FIG. 10 is a cross-sectional view taken along line A-A of the inkjet print head according to the second embodiment of the present invention;

FIG. 11 is an exploded perspective view showing an inkjet print head according a third embodiment of the present invention;

FIG. 12 is an assembly perspective view of the inkjet print head shown in FIG. 11;

FIG. 13 is a cross-sectional view taken along line D-D of the inkjet print head shown in FIG. 12;

FIG. 14 is a cross-sectional view taken along line E-E of the inkjet print head shown in FIG. 12; and

FIG. 15 is a view showing an overall configuration of the inkjet print head shown in FIG. 12.

### DETAILED DESCRIPTION OF THE EMBODIMENTS

In the inkjet print head according to the related art, ink only flows in one direction (from a common channel to a nozzle), such that a nozzle obstruction phenomenon due to foreign objects or air bubbles may occur in the nozzle.

In the present invention, an object of which is to solve the above-mentioned problem, a first pressure chamber and a second pressure chamber are connected to one another so that ink is circulated in an inkjet print head.

In the inkjet print head having the above-described ink circulation structure according to the embodiment of the present invention, the ink is continuously circulated so that the phenomenon in which the foreign objects or air bubbles are concentrated in the nozzle may be alleviated, whereby the nozzle obstruction phenomenon in the nozzle may be decreased.

Further, according to the embodiment of the present invention, a plurality of actuators respectively provided with a plurality of pressure chambers generate pressure, whereby a discharge speed and a discharge force of the ink may be improved.

Hereinafter, embodiments of the present invention will be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of components may be exaggerated for clarity, and the same reference numerals will be used throughout to designate the same or like components.

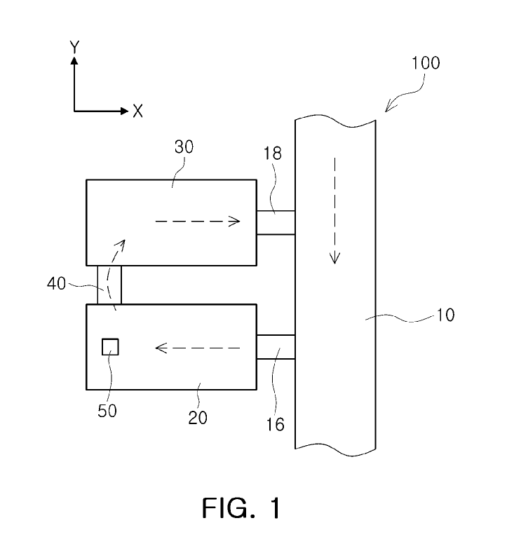

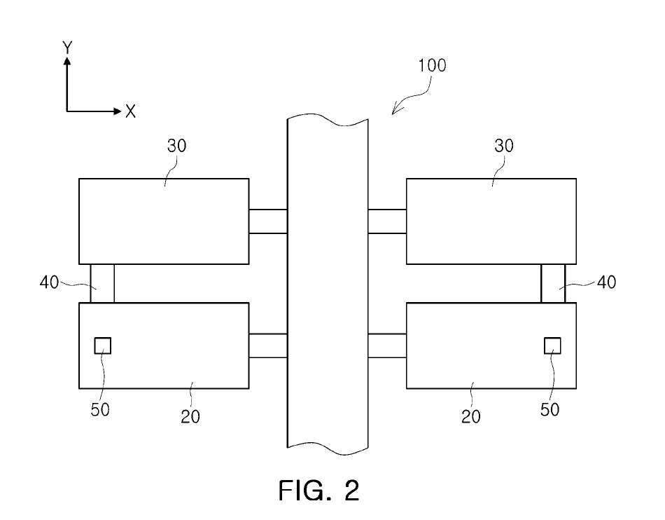

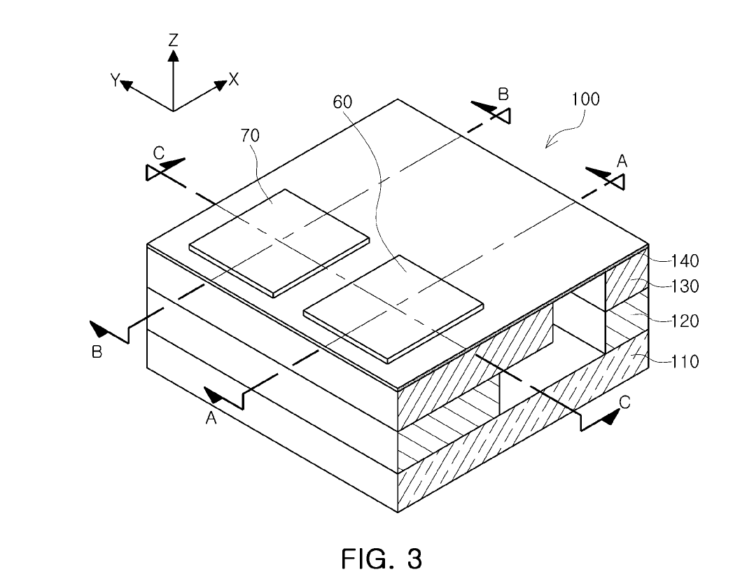

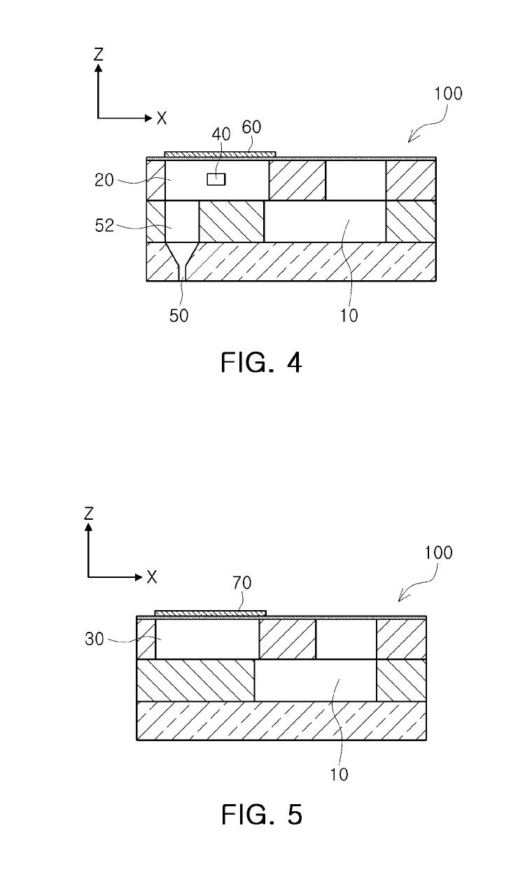

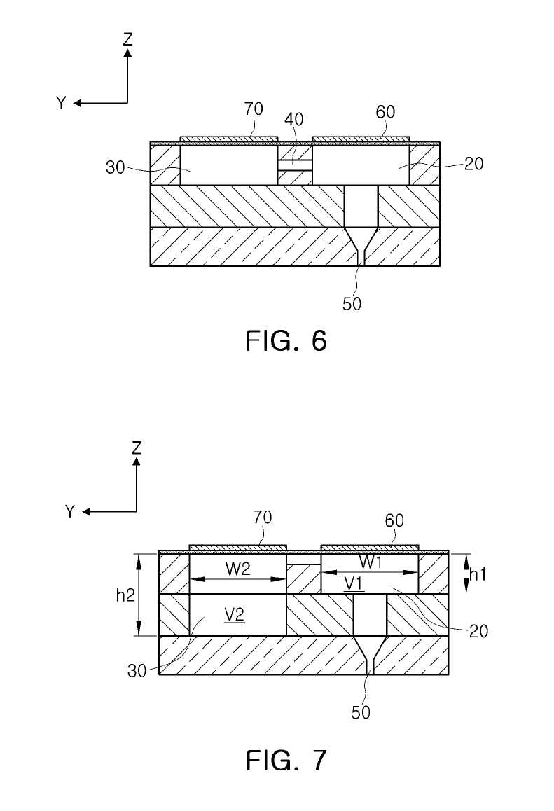

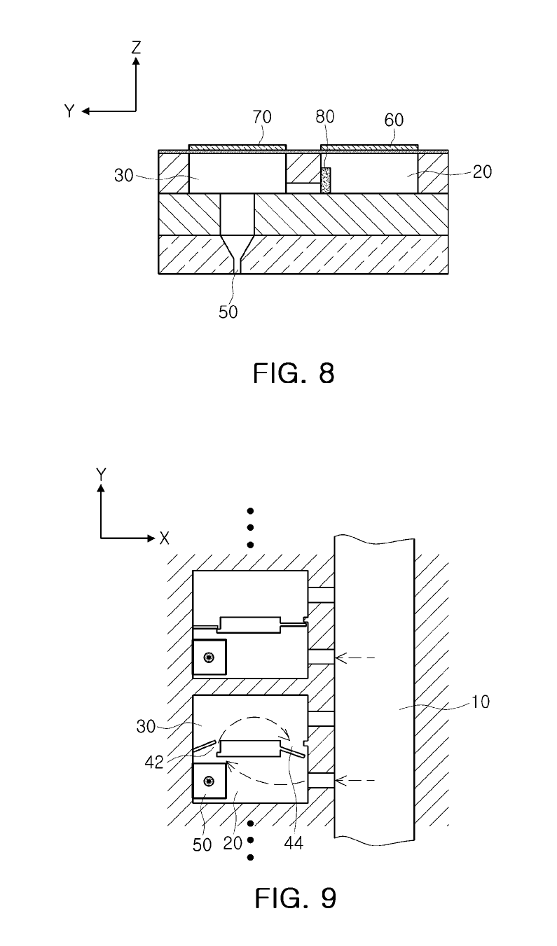

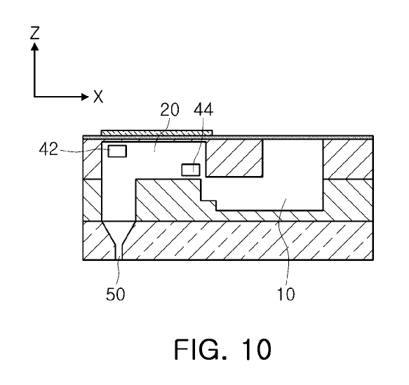

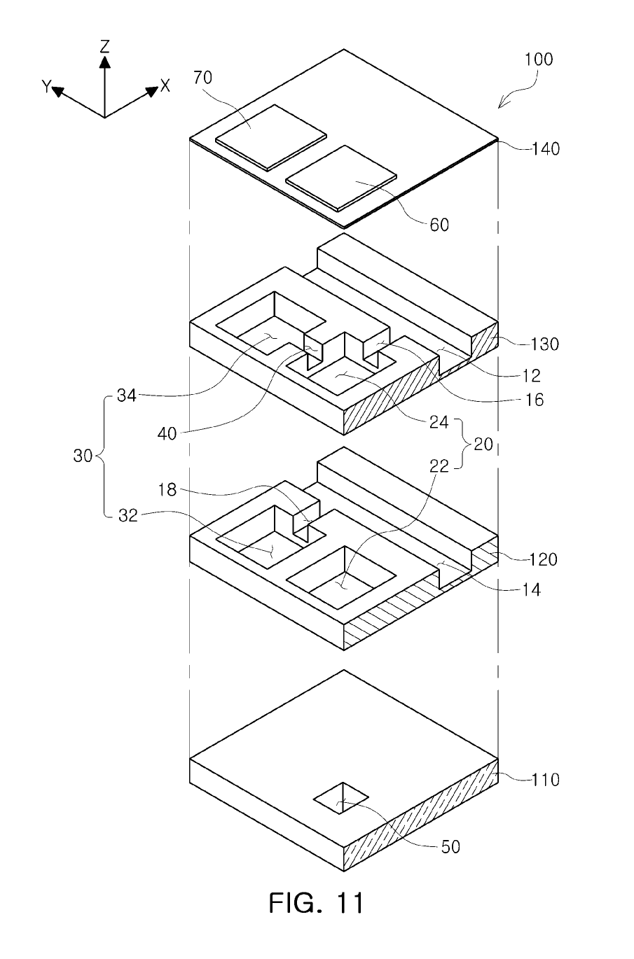

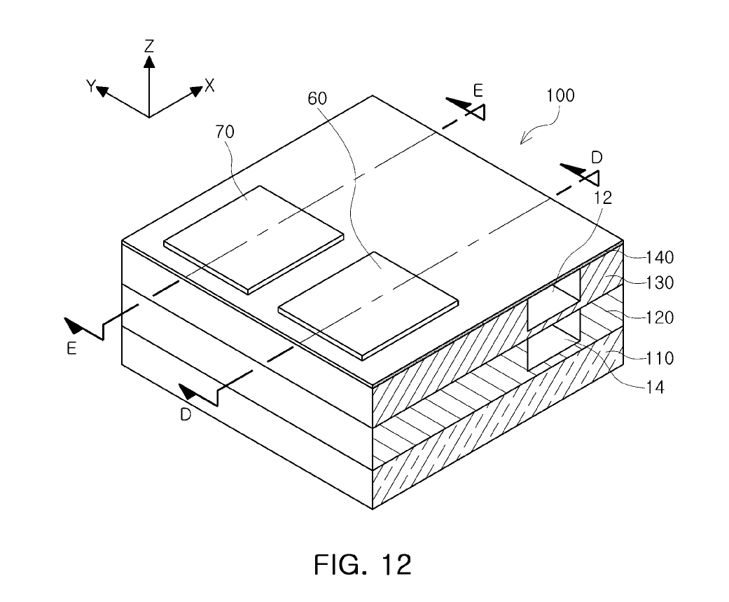

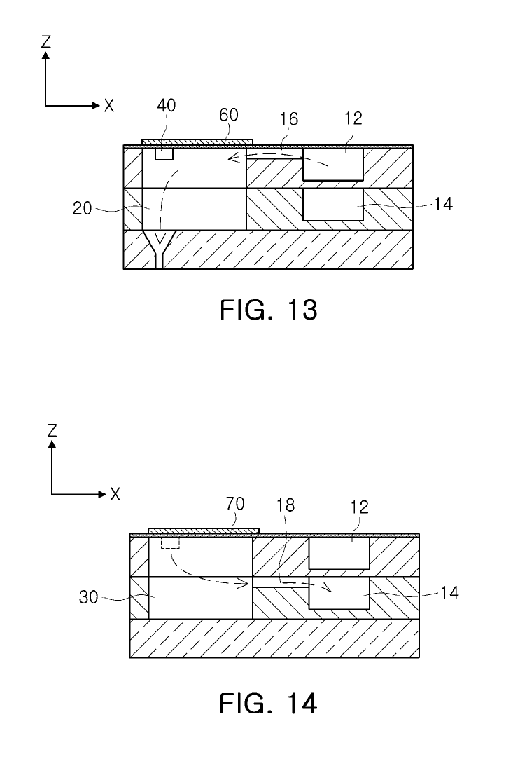

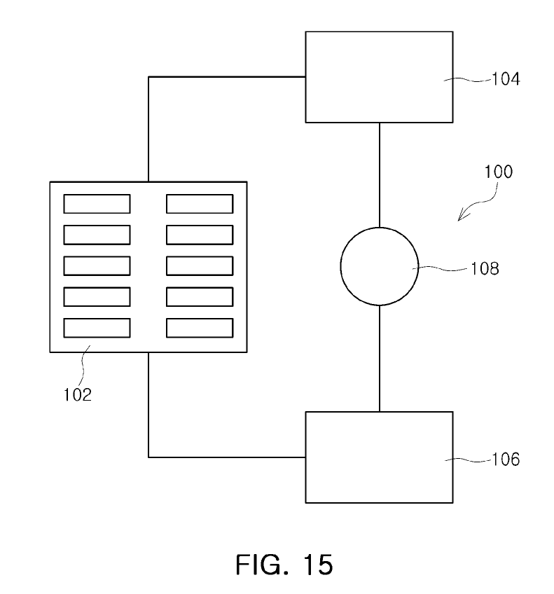

FIGS. 1 and 2 are main configuration views showing an inkjet print head according to a first embodiment of the present invention; FIG. 3 is a partially cut-away perspective view showing the inkjet print head according the first embodiment of the present invention; FIG. 4 is a cross-sectional view taken along line A-A of the inkjet print head shown in FIG. 3; FIG. 5 is a cross-sectional view taken along line B-B of the inkjet print head shown in FIG. 3; FIG. 6 is a cross-sectional view taken along line C-C of the inkjet print head shown in FIG. 3; FIG. 7 is a cross-sectional view describing another form of the inkjet print head taken along line C-C of the inkjet print head shown in FIG. 3; FIG. 8 is a cross-sectional view describing another form of the inkjet print head taken along line C-C of the inkjet print head shown in FIG. 3; FIG. 9 is a main configuration view showing an inkjet print head according to a second embodiment of the present invention; FIG. 10 is a cross-sectional view taken along line A-A of the inkjet print head according to the second embodiment of the present invention; FIG. 11 is an exploded perspective view showing an inkjet print head according a third embodiment of the present invention; FIG. 12 is an assembly perspective view of the inkjet print head shown in FIG. 11; FIG. 13 is a cross-sectional view taken along line D-D of the inkjet print head shown in FIG. 12; FIG. 14 is a cross-sectional view taken along line E-E of the inkjet print head shown in FIG. 12; and FIG. 15 is a view showing an overall configuration of the inkjet print head shown in FIG. 12.

The configuration of an inkjet print head according to a first embodiment of the present invention will be described with reference to FIGS. 1 and 2.

An inkjet print head 100 according to the first embodiment of the present invention may include a common channel 10, a first pressure chamber 20, a second pressure chamber 30, and a connection channel 40.

The common channel 10 may be elongated in a first direction (a Y axis direction of FIG. 1) of the inkjet print head 100. The common channel 10 formed as described above may be connected to an ink supplying part and supply ink stored in the ink supplying part to one or more pressure chambers.

The first pressure chamber 20 may be formed on one side of the common channel 10 and may be connected to the common channel 10. Here, the first pressure chamber 20 and the common channel 10 may be connected to each other by a restrictor 16.

The first pressure chamber 20 may be provided with a nozzle 50. The nozzle 50 may have a predetermined size and the ink stored in the first pressure chamber 20 may be discharged therethrough.

The second pressure chamber 30 may be formed on one side of the common channel 10 and may be connected to the common channel 10. Here, the second pressure chamber 30 and the common channel 10 may be connected to each other by a restrictor 18.

The second pressure chamber 30 may be disposed in parallel with the first pressure chamber 20. More specifically, the second pressure chamber 30 may be disposed in parallel with the first pressure chamber 20 on a side of the first pressure chamber 20. The second pressure chamber 30 formed as described above may have a size that is equal or similar to that of the first pressure chamber 20.

The second pressure chamber 30 may be connected to the first pressure chamber 20. More specifically, the second pressure chamber 30 may be connected to the first pressure chamber 20 by the connection channel 40. Therefore, the ink in the first pressure chamber 20 may be moved to the second pressure chamber 30 through the connection channel 40. Similarly, the ink in the second pressure chamber 30 may be moved to the first pressure chamber 20 through the connection channel 40.

In the inkjet print head 100 configured as described above, the ink in the first pressure chamber 20 may be moved to the second pressure chamber 30 through the connection channel 40. That is, when driving force is applied to the first pressure chamber 20, a certain amount of the ink in the first pressure chamber 20 may be discharged through the nozzle 50 and the remainder may be moved to the second pressure chamber 30. In addition, the ink that is moved to the second pressure chamber 30 may be introduced to the common channel 10 or may be re-introduced to the first pressure chamber 20. Therefore, in the inkjet print head 100 according to the embodiment of the present invention, since the ink may be moved and circulated in a sequence of the common channel 10, the first pressure chamber 20, the second pressure chamber 30, and the common channel 10, an obstruction of the nozzle 50 due to foreign objects or air bubbles may be alleviated.

Meanwhile, although FIG. 1 shows that a pair of the first pressure chamber 20 and the second pressure chamber 30 is connected to the common channel 10, a plurality of pairs of first pressure chambers 20 and second pressure chambers 30 may be repeatedly formed in a length direction of the common channel 10 (the Y axis direction of FIG. 1). In addition, the plurality of pairs of first pressure chambers 20 and second pressure chambers 30 may be symmetrically disposed while having the common channel 10 therebetween, as shown in FIG. 2.

Hereinafter, the configuration of the inkjet print head according to the first embodiment of the present invention will be described in detail with reference to FIGS. 3 through 8.

The inkjet print head 100 may include a first substrate 110, a second substrate 120, a third substrate 130, and a vibration plate 140. Here, the substrates 110, 120, 130 may be provided with the common channel 10, the first pressure chamber 20, the second pressure chamber 30, and the connection channel 40, and the vibration plate 140 may be provided with a plurality of actuators 60 and 70 generating pressure in the pressure chambers 20 and 30.

For reference, although FIG. 3 shows the inkjet print head 100 configured of the three substrates 110, 120, and 130 and one vibration plate 140, the number of substrates may be increased or decreased, as required.

The inkjet print head 100 may have different cross sectional structures according to positions in which the pressure chambers 20 and 30 are formed. More specifically, a cross section (taken along line A-A) of a portion of the inkjet print head 100 in which the first pressure chamber 20 is formed and a cross section (taken along line B-B) of a portion of the inkjet print head 100 in which the second pressure chamber 30 is formed may be different to each other.

The cross section (taken along line A-A) of the portion in which the first pressure chamber 20 is formed may have a structure in which all of the common channel 10, the first pressure chamber 20, and the nozzle 50 are connected to each other, as shown in FIG. 4. That is, in this cross sectional structure, the ink in the common channel 10 may be introduced to the first pressure chamber 20 and then discharged through the nozzle 50. Here, pressure or driving force required for discharging the ink may be provided by a first actuator 60 which is disposed on the first pressure chamber 20. For reference, the reference numeral 52 may be a damper space for alleviating rapid introduction of the ink from the first pressure chamber 20 into the nozzle 50.

On the contrary, the cross section of the portion in which the second pressure chamber 30 is formed may have a structure in which only the common channel 10 and the second pressure chamber 30 are connected to each other, as shown in FIG. 5. Therefore, the ink in the common channel 10 may only be moved to the second pressure chamber 30 and the ink in the second pressure chamber 30 may also only be moved to the common channel 10.

Meanwhile, a second actuator 70 may be disposed on the second pressure chamber 30. The second actuator 70 may provide the pressure or the driving force to the second pressure chamber 30, whereby the ink in the second pressure chamber 30 may be reintroduced into the common channel 10.

The first pressure chamber 20 and the second pressure chamber 30 having the different cross sectional structures as described above may be connected to each other by the connection channel 40 as shown in FIG. 6. Therefore, the ink in the first pressure chamber 20 may be discharged through the nozzle 50 and moved to the second pressure chamber 30 when the first actuator 60 is driven.

Meanwhile, the first actuator 60 and the second actuator 70 may be simultaneously operated in order to smoothly discharge the ink. Alternatively, the first actuator 60 and the second actuator 70 may be sequentially operated, while having a predetermined interval of time between operations thereof.

Another form of the inkjet print head 100 will be described with reference to FIG. 7.

In another form of the inkjet print head 100, the first pressure chamber 20 and the second pressure chamber 30 may have different volumes. More specifically, a first volume V1 of the first pressure chamber 20 may be different from a second volume V2 of the second pressure chamber 30. To this end, a width W1 or a height h1 of the first pressure chamber 20 may be different from a width W2 or a height h2 of the second pressure chamber 30. Meanwhile, although FIG. 7 shows that the volume V2 of the second pressure chamber 30 is greater than the volume V1 of the first pressure chamber 20, the volume V1 of the first pressure chamber 20 may be greater than the volume V2 of the second pressure chamber 30 as necessary.

As described above, when the first pressure chamber 20 and the second pressure chamber 30 have different volumes, the ink may smoothly flow between the first pressure chamber 20 and the second pressure chamber 30. Therefore, it may be effective to change the volumes of the pressure chambers 20 and 30 in increasing ink circulation efficiency.

Meanwhile, although FIG. 7 shows that the volumes of the first pressure chamber 20 and the second pressure chamber 30 are changed, the first actuator 60 and the second actuator may have different sizes as necessary, whereby the above-mentioned effect may be achieved.

Another form of the inkjet print head 100 will be described with reference to FIG. 8.

In another form of the inkjet print head 100, the nozzle 50 may be formed in the second pressure chamber 30. In addition, the connection channel 40 may be equipped with a filter member 80. Here, the filter member 80 may remove the foreign objects or the air bubbles contained within the ink.

In addition, the connection channel 40 may have a cross-sectional shape in which it is gradually extended from the first pressure chamber 20 toward the second pressure chamber 30. The connection channel 40 formed as described above may facilitate ink flow from the first pressure chamber 20 to the second pressure chamber 30 and interrupt ink flow from the second pressure chamber 30 to the first pressure chamber 20.

Hereinafter, other embodiments of the present invention will be described. For reference, in the following embodiments, the same reference numerals will be used to describe the same components as those of the first embodiment. In addition, a detailed description of these components will be omitted.

An inkjet print head according to a second embodiment of the present invention will be described with reference to FIGS. 9 and 10.

The inkjet print head 100 according to the second embodiment of the present invention may be distinguished from that of the first embodiment by a connected structure of the first pressure chamber 20 and the second pressure chamber 30 therebetween.

In the present embodiment, the first pressure chamber 20 and the second pressure chamber 30 may be connected by a first connection channel 42 and a second connection channel 44. More specifically, the first connection channel 42 may connect between one end of the first pressure chamber 20 and one end of the second pressure chamber 30, and the second connection channel 44 may connect between the other end of the first pressure chamber 20 and the other end of the second pressure chamber 30. Here, the ink may flow from the first pressure chamber 20 to the second pressure chamber 30 through the first connection channel 42, the ink may flow from the second pressure chamber 30 to the first pressure chamber 20 through the second connection channel 44.

To this end, the first connection channel 42 and the second connection channel 44 may be provided with check valves and 48, respectively. More specifically, the first connection channel 42 may be provided with a first check valve 46 only allowing ink flow from the first pressure chamber 20 to the second pressure chamber 30, and the second connection channel 44 may be provided with a second check valve 48 only allowing ink flow from the second pressure chamber 30 to the first pressure chamber 20.

Here, the respective check valves 46 and 48 may have a thin film shape as shown in FIG. 9. The above-mentioned thin film shape may be formed through an etching process.

As shown in FIG. 10, the first connection channel 42 and the second connection channel 44 may be formed at different heights. For example, the first connection channel 42 in which the ink flows from the first pressure chamber 20 to the second pressure chamber 30 may be formed upwardly, and the second connection channel 44 in which the ink flows from the second pressure chamber 30 to the first pressure chamber 20 may be formed downwardly. However, the above-mentioned structure is only an example and the heights at which the first connection channel 42 and the second connection channel 44 are formed may be interchangeable.

Next, an operational principle of the inkjet print head 100 according to the second embodiment of the present invention will be described.

The first pressure chamber 20 and the second pressure chamber 30 may be supplied with the ink from the common channel 10. Therefore, in a state in which the actuators 60 and 70 are not operated, the ink may be filled in the first pressure chamber 20 and the second pressure chamber 30.

In this state, when only the first actuator 60 is operated, an ink circulation phenomenon in which the ink in the first pressure chamber 20 is introduced into the second pressure chamber 30 through the first connection channel 42 and the ink in the second pressure chamber 30 is introduced into the first pressure chamber 20 through the second connection channel 44 may occur. However, in this case, since the first pressure chamber 20 and the second pressure chamber 30 do not have sufficient pressure therein, the ink is not discharged through the nozzle 50.

Similarly, in the state in which the ink is filled in the first pressure chamber 20 and the second pressure chamber 30, when only the second actuator 70 is operated, an ink circulation phenomenon in which the ink in the second pressure chamber 30 is introduced into the first pressure chamber 20 through the second connection channel 44 and the ink in the first pressure chamber 20 is introduced into the second pressure chamber 30 through the first connection channel 42 may occur. However, in this case, since the first pressure chamber 20 and the second pressure chamber 30 do not have sufficient pressure therein, the ink is not discharged through the nozzle 50.

On the other hand, when the first actuator 60 and the second actuator 70 are simultaneously operated, the first pressure chamber 20 and the second pressure chamber 30 may have sufficient pressure therein. Therefore, in this case, the ink may be circulated between the first pressure chamber 20 and the second pressure chamber 30 and may be discharged through the nozzle 50.

In the inkjet print head 100 configured as described above, the first pressure chamber 20 and the second pressure chamber 30 are connected to each other by the two connection channels 42 and 44, whereby ink circulation and ink discharge may be selectively performed in the pressure chambers 20 and 30.

An inkjet print head according to a third embodiment of the present invention will be described with reference to FIGS. 11 through 15.

The inkjet print head 100 according to the third embodiment of the present invention may be distinguished from the above-described embodiments in that it includes a plurality of common channels. That is, the inkjet print head 100 according to the third embodiment of the present invention may be distinguished from the above-described embodiments in that it forms a structure of circulating the ink through the plurality of common channels.

The inkjet print head 100 may include the first substrate 110, the second substrate 120, the third substrate 130, and the vibration plate 140. However, the number of substrates configuring the inkjet print head 100 is not limited thereto, but may be increased or decreased as necessary. For example, the inkjet print head 100 may be configured of two substrates and one vibration plate 140 or may be configured of four substrates and one vibration plate 140.

The first substrate 110 may be provided with the nozzle 50. Here, the nozzle 50 may have a cross sectional diameter decreasing in a thickness direction (downwardly of a Z axis direction of FIG. 11) of the first substrate 110.

The second substrate 120 may be provided with one portion 22 of the first pressure chamber 20, one portion 32 of the second pressure chamber 30, and the second common channel 14. Here, one portion 22 of the first pressure chamber 20 may be connected to the nozzle 50 in the state in which the first substrate 110 and the second substrate 120 are combined with each other.

Meanwhile, in the second substrate 120, one portion 32 of the second pressure chamber 30 may be connected to the second common channel 14 through the restrictor 18. The second pressure chamber 30 connected to the second common channel 14 may discharge the ink to the second common channel 14.

The third substrate 130 may be provided with the other portion 24 of the first pressure chamber 20 and the other portion 34 of the second pressure chamber 30, the first common channel 12, and the connection channel 40. Here, the other portion 24 of the first pressure chamber 20 may be combined with one portion 22 of the first pressure chamber 20 to thereby form the first pressure chamber 20 in the state in which the second substrate 120 and the third substrate 130 are combined with each other. Similarly, the other portion 34 of the second pressure chamber 30 may be combined with one portion 32 of the second pressure chamber 30 to thereby form the second pressure chamber 30 in the state in which the second substrate 120 and the third substrate 130 are combined with each other.

Meanwhile, in the third substrate 130, the other portion 24 of the first pressure chamber 20 may be connected to the first common channel 12 through the restrictor 16. The first pressure chamber 20 connected to the first common channel 12 may be supplied with the ink from the first common channel 12.

Further, in the third substrate 130, the first pressure chamber 20 and the second pressure chamber 30 may be interconnected to each other by the connection channel 40. Therefore, in the third substrate 130, the ink that is introduced into the first pressure chamber 20 may be moved to the second pressure chamber 30 through the connection channel 40.

The vibration plate 140 may be combined with the third substrate 130. The first actuator 60 and the second actuator 70 applying the pressure to the first pressure chamber 20 and the second pressure chamber 30, respectively, may be formed on the vibration plate 140.

The inkjet print head 100 configured as described above may include two common channels 12 and 14 separated from each other, as shown in FIG. 12.

Here, the first common channel 12 may be connected to the first pressure chamber 20 as shown in FIG. 13 and the second common channel 14 may be connected to the second pressure chamber 30 as shown in FIG. 14.

Therefore, in the inkjet print head 100 according to the present embodiment of the present invention, the ink may flow in a sequence of the first common channel 12, the first pressure chamber 20, the second pressure chamber 30, and the second common channel 14.

Meanwhile, the first common channel 12 may be connected to an ink supplying part 104 storing the ink and the second common channel 14 may be connected to an ink recovering part 106 storing the ink which is not discharged through the nozzle 50.

Here, the ink supplying part 104 and the ink recovering part 106 are connected to each other, thereby allowing the ink to continuously be circulated. Therefore, according to the present embodiment, ink discharge efficiency and discharge performance of the inkjet print head 100 may be improved through continuous ink circulation.

A degassing device 108 or a filtering device may be installed between the ink supplying part 104 and the ink recovering part 106. In this case, the air bubbles or the foreign objects contained in the circulating ink may be removed or alleviated, whereby the discharge efficiency and the discharge performance of the inkjet print head 100 may be further improved. For reference, the reference numeral 102 denotes a head part formed of the plurality of substrates 110, 120, 130, and 140.

As set forth above, the inkjet print head according to embodiments of the present invention allows ink to be continuously circulated, whereby the ink discharge characteristics and efficiency may be improved.

While the present invention has been shown and described in connection with the embodiments, it will be apparent to those skilled in the art that modifications and variations can be made without departing from the spirit and scope of the invention as defined by the appended claims.

What is claimed is:

1. An inkjet print head, comprising:
a first pressure chamber connected to a common channel;
a second pressure chamber connected to the common channel and disposed in parallel with the first pressure chamber;
a connection channel connecting the first pressure chamber and the second pressure chamber; and
a nozzle formed in the first pressure chamber or the second pressure chamber.

2. The inkjet print head of claim 1, further comprising a first actuator disposed on the first pressure chamber and a second actuator disposed on the second pressure chamber.

3. The inkjet print head of claim 1, wherein the connection channel includes:
a first connection channel connecting one end of the first pressure chamber and one end of the second pressure chamber; and
a second connection channel connecting the other end of the first pressure chamber and the other end of the second pressure chamber.

4. The inkjet print head of claim 3, wherein the first connection channel and the second connection channel are formed at different heights.

5. The inkjet print head of claim 3, further comprising:
a first check valve installed in the first connection channel and only allowing ink flow from the first pressure chamber to the second pressure chamber; and
a second check valve installed in the second connection channel and only allowing ink flow from the second pressure chamber to the first pressure chamber.

6. The inkjet print head of claim 1, wherein the connection channel is mounted with a filter member capable of filtering foreign objects contained in ink.

7. An inkjet print head, comprising:
a first pressure chamber connected to a first common channel;
a second pressure chamber connected to a second common channel and disposed in parallel with the first pressure chamber;
a connection channel connecting the first pressure chamber and the second pressure chamber; and
a nozzle formed in the first pressure chamber or the second pressure chamber.

8. The inkjet print head of claim 7, wherein the first common channel is connected to an ink supplying part, and
the second common channel is connected to an ink recovering part.

9. The inkjet print head of claim 8, further comprising a degassing device connected to the second common channel and filtering or removing air bubbles contained in ink.

10. The inkjet print head of claim 8, wherein the ink supplying part and the ink recovering part are connected to each other so that ink is circulated therebetween.

11. The inkjet print head of claim 7, further comprising a first actuator disposed on the first pressure chamber and a second actuator disposed on the second pressure chamber.

12. The inkjet print head of claim 7, wherein the connection channel includes:
a first connection channel connecting one end of the first pressure chamber and one end of the second pressure chamber; and
a second connection channel connecting the other end of the first pressure chamber and the other end of the second pressure chamber.

13. The inkjet print head of claim 12, wherein the first connection channel and the second connection channel are formed at different heights.

14. The inkjet print head of claim 12, further comprising:
a first check valve installed in the first connection channel and only allowing ink flow from the first pressure chamber to the second pressure chamber; and
a second check valve installed in the second connection channel and only allowing ink flow from the second pressure chamber to the first pressure chamber.

15. The inkjet print head of claim 7, wherein the connection channel or the second common channel is mounted with a filter member capable of filtering foreign objects contained in ink.
